(19) United States
(12) Patent Application Publication
(10) Pub. No.: US 2015/0103944 A1
(43) Pub. Date: Apr. 16, 2015

(54) MOBILE COMMUNICATION METHOD AND RADIO TERMINAL

(71) Applicant: NIPPON HOSO KYOKAI, Tokyo (JP)

(72) Inventors: Takuya SHITOMI, Tokyo (JP); Kenichi MURAYAMA, Tokyo (JP); Makoto TAGUCHI, Tokyo (JP); Shingo ASAKURA, Tokyo (JP); Kazuhiko SHIBUYA, Tokyo (JP)

(73) Assignee: NIPPON HOSO KYOKAI, Tokyo (JP)

(21) Appl. No.: 14/051,672

(22) Filed: Oct. 11, 2013

(51) Int. Cl. H04L 27/26

(52) U.S. Cl. CPC H04L 27/2627; H04L 27/2649
USPC 375/295; 375/340

(57) ABSTRACT

A transmission apparatus configured to transmit four OFDM signals from four transmission antennas includes: a pilot signal insertion unit configured to generate four types of OFDM symbols by inserting pilot signals of different patterns into four types of transmission signals; and an OFDM signal generation unit configured to generate four OFDM signals by modulating respective carriers of the four types of OFDM symbols. The pilot signal insertion unit is configured to insert, with respect to first and second transmission signals, pilot signals having a meaningful value and pilot signals of null signals; insert, with respect to third and fourth transmission signals, pilot signals having a meaningful value, pilot signals obtained by inverting codes of the pilot signals having a meaningful value, and pilot signals of null signals; insert, with respect to the first and third transmission signals, the pilot signals of null signals in identical predetermined positions; and insert, with respect to the second and fourth transmission signals, the pilot signals of null signals in positions different from the identical predetermined positions.

### BACKGROUND OF THE INVENTION

1. Field of the Invention

The present invention relates to a transmission apparatus and a reception apparatus in connection with a transmission system configured to perform Multi Input Multi Output (MIMO) transmission using a plurality of Orthogonal Frequency Division Multiplexing (OFDM) signals of the same frequency band.

2. Description of the Related Art

Conventionally, there has been known a scheme in which, when estimating a transmission path response of one of a plurality of OFDM signals transmitted in the same frequency band, pilot signals of the other OFDM signals are used as null signals to estimate the transmission path response (see, for example, Patent Literature 1). This scheme will be referred to as a null pilot scheme in this specification. There is also known a scheme in which a transmission path response is estimated by inverting the code of a pilot signal so that the pilot signal is endowed with orthogonality (see, for example, Patent Literature 2). This scheme will be referred to as a code-inverted pilot scheme in this specification.

Pilot signal patterns of the null pilot scheme and the code-inverted pilot scheme will be described with reference to FIGS. 18 to 21 by using an example of an OFDM signal transmission system, the transmission apparatus of which has two transmission antennas, the reception apparatus of which has at least two reception antennas, and which transmits two OFDM signals in the same frequency band. FIGS. 18 to 21 illustrate, among OFDM symbols, only the smallest unit of repetition of a pilot signal, omitting any non-pilot signal, such as a data signal. In addition, pattern 1 refers to a pilot signal pattern of an OFDM signal transmitted from one transmission antenna, and pattern 2 refers to a pilot signal pattern of an OFDM signal transmitted from the other transmission antenna. In connection with OFDM symbols in the drawings, the rightward direction corresponds to the carrier (frequency) direction, and the downward direction corresponds to the symbol (time) direction.

FIG. 18 is a diagram illustrating pilot signal patterns when the null pilot scheme is applied to a system configured to transmit two OFDM signals in the same frequency band. In the drawing, squares indicate pilot signals having a meaningful value, and circles indicate pilot signals of null signals. In FIG. 19, positions of transmission path responses obtained directly (that is, without using interpolation) from the pilot signals of FIG. 18 are indicated by circles marked with oblique lines. In this specification, given symbol number s and carrier number c, a pilot signal is represented as P(s, c). In the null pilot scheme, transmission path responses of positions of P(1, 1) and P(2, 2) are obtained in the case of pattern 1 of FIG. 18, and transmission path responses of positions of P(1, 2) and P(2, 1) are obtained in the case of pattern 2 of FIG. 18. The null pilot scheme can have zero power consumption, which is used for transmission, in the range where pilot signals are null signals.

FIG. 20 is a diagram illustrating pilot signals patterns of OFDM signals in the case of the code-inverted pilot scheme. In the drawings, squires indicate pilot signals having a meaningful value, circles indicate pilot signals of null signals, and “1” and “−1” written inside the squires means that the corresponding pilot signals have inverted codes. In FIG. 21, positions of transmission path responses directly obtained from the pilot signals of FIG. 20 are indicated by circles marked with oblique lines. In this specification, the reception signal of a pilot signal P(s, c) is represented as Rx(s, c). In the code-inverted pilot scheme, transmission path responses of positions of points P1 and P2 in the drawing, for example, are obtained, assuming that the amplitude value of pilot signals is one, by the following equation:

P1: (Rx(1, 1)+Rx(1, 2))/2

P2: (Rx(1, 1)−Rx(1, 2))/2

When two OFDM signals are transmitted in the same frequency band, half the pilot signals become null signals in the null pilot scheme; as a result, power consumption for transmitting pilot signals decreases by half, and the frequency of directly obtaining transmission path responses also decreases by half. In the code-inverted pilot scheme, no pilot signals become null signals, so that power consumption for transmitting pilot signals does not decrease, while transmission path responses can be obtained at a high frequency.

Problems of the null pilot scheme and the code-inverted pilot scheme, when the number of OFDM signals transmitted in the same frequency band exceeds two, will be described. It will be assumed in the following description that the number of transmission antennas of the transmission apparatus is four, the number of reception antennas of the reception apparatus is at least four, and four OFDM signals are transmitted in the same frequency band.

FIGS. 22A to 22C are diagrams illustrating pilot signal patterns when the null pilot scheme is applied to a system configured to transmit four OFDM signals in the same frequency band. FIG. 22A illustrates an example of arranging pilot signals, which have a meaningful value, along a straight line in the symbol direction, FIG. 22B illustrates an example of arranging pilot signals, which have a meaningful value, along a straight line in the carrier direction, and FIG. 22C illustrates an example of arranging pilot signals, which have a meaningful value, obliquely. In addition, positions of transmission path responses directly obtained from the pilot signals are indicated by circles marked with oblique lines. In FIG. 22A, pilot signals are inserted into different carriers of four OFDM signals so that, in a range where one OFDM signal is transmitting a pilot signal, the other OFDM signals become null signals; as a result, transmission path responses are obtained in positions of insertion of pilot signals having a meaningful value, without performing a special operation. In FIGS. 22B and 22C, transmission path responses are similarly obtained in positions of insertion of pilot signals having a meaningful value. That is, in FIGS. 22A to 22C, transmission path responses are directly obtained four times in the range of four symbols×four carriers, so that power consumption for transmitting pilot signals decreases to ¼.

As such, application of the null pilot scheme reduces power consumption for transmitting pilot signals to ¼. However, there is a problem in that the number of transmission path responses directly obtained in the range of four symbols×four carriers with respect to each OFDM signal is only four, lowering the frequency of estimation of transmission path responses.

FIGS. 23A to 23D are diagrams illustrating pilot signal patterns when the code-inverted pilot scheme is applied to a system configured to transmit four OFDM signals in the same frequency band. In connection with the pilot signals illustrated in FIGS. 23A to 23D, transmission path responses are obtained by performing addition/subtraction of pilot signals in four symbol ranges with respect to each of the carriers. Positions of transmission path responses directly obtained from the pilot signals are indicated by circles marked with oblique lines.

FIG. 23A illustrates an example of arranging pilot signals, which have inverted codes, along a straight line in the symbol direction, and FIG. 23B illustrates an example of arranging pilot signals, which have inverted codes, along a straight line in the carrier direction. Transmission path responses of points P1 to P4 in FIG. 23A are obtained by the following equation:

P1: (Rx(1, 1)+Rx(1, 2)+Rx(1, 3)+Rx(1,4))/4

P2: (Rx(1, 1)+Rx(1, 2)−Rx(1, 3)−Rx(1, 4))/4

P3: (Rx(1, 1)−Rx(1, 2)−Rx(1, 3)+Rx(1, 4))/4

P4: (Rx(1, 1)−Rx(1, 2)+Rx(1, 3)−Rx(1, 4))/4

In FIGS. 23A and 23B, the number of transmission path responses directly obtained in the range of four symbols×four carriers with respect to each OFDM signal is eight.

FIG. 23C illustrates an example of arranging pilot signals, which have inverted codes, in an oblique direction, and FIG. 23D illustrates an example of arranging pilot signals, which have inverted codes, in longitudinal/transverse/oblique directions. In FIGS. 23C and 23D, the number of transmission path responses directly obtained in the range of four symbols×four carriers with respect to each OFDM signal is 16. As such, application of the code-inverted pilot scheme has a problem in that, in the examples of FIGS. 23C and 23D, the number of transmission path responses directly obtained in the range of four symbols×four carriers is 16, as a result of which transmission path responses can be obtained at a high frequency, but power consumption for transmitting pilot signals cannot be reduced.

### SUMMARY OF THE INVENTION

In order to solve the above-mentioned problems, a transmission apparatus according to the present invention is a transmission apparatus configured to transmit four OFDM signals from four transmission antennas. The transmission apparatus includes: a pilot signal insertion unit configured to generate four types of OFDM symbols by inserting pilot signals of different patterns into four types of transmission signals; and an OFDM signal generation unit configured to generate four patterns of OFDM signals by modulating respective carriers of the four types of OFDM symbols. The pilot signal insertion unit is configured to insert, with respect to first and second transmission signals, pilot signals having a meaningful value and pilot signals of null signals; insert, with respect to third and fourth transmission signals, pilot signals having a meaningful value, pilot signals obtained by inverting codes of the pilot signals having a meaningful value, and pilot signals of null signals; insert, with respect to the first and third transmission signals, the pilot signals of null signals in identical predetermined positions; and insert, with respect to the second and fourth transmission signals, the pilot signals of null signals in positions different from the identical predetermined positions.

In addition, the transmission apparatus according to the present invention further includes a space-time encoding unit configured to generate four types of space-time encoding signals by performing space-time encoding with respect to signals of two lines, respectively, and the four types of transmission signals are the four types of space-time encoding signals generated by the space-time encoding unit.

In addition, in connection with the transmission apparatus according to the present invention, the pilot signal insertion unit is configured to set, with respect to the four types of transmission signals, half the number of inserted pilot signals with pilot signals of null signals and insert, with respect to the third and fourth transmission signals, pilot signals so that the number of the pilot signals having a meaningful value is equal to the number of pilot signals obtained by inverting codes of the pilot signals having a meaningful value.

Furthermore, in order to solve the above-mentioned problems, a reception apparatus according to the present invention is a reception apparatus configured to receive four OFDM signals transmitted from the above-described transmission apparatus using four reception antennas. The reception apparatus includes an OFDM demodulation unit configured to demodulate the received four OFDM signals and estimate baseband signals corresponding to respective reception antennas and transmission path responses.

Furthermore, in order to solve the above-mentioned problems, a reception apparatus according to the present invention is a reception apparatus configured to receive four OFDM signals transmitted from the above-described transmission apparatus using two reception antennas. The reception apparatus includes: an OFDM demodulation unit configured to demodulate the received four OFDM signals and estimate baseband signals corresponding to respective reception antennas and transmission path responses; and a space-time decoding unit configured to generate space-time decoding signals by performing space-time decoding using the baseband signals and the transmission path responses.

Furthermore, in order to solve the above-mentioned problems, a reception apparatus according to the present invention is a reception apparatus configured to receive four OFDM signals transmitted from the above-described transmission apparatus using at least four reception antennas. The reception apparatus includes: an OFDM demodulation unit configured to demodulate the received four OFDM signals and estimate baseband signals corresponding to respective reception antennas and transmission path responses; a space-time decoding unit configured to generate space-time decoding signals by performing space-time decoding using the baseband signals and the transmission path responses; and a composition unit configured to perform diversity composition of the space-time decoding signals.

### BRIEF DESCRIPTION OF THE DRAWINGS

FIG. 1 is a block diagram illustrating a configuration of a transmission apparatus according to a first embodiment of the present invention;

FIG. 2 is a block diagram illustrating a configuration of an OFDM modulation unit of the transmission apparatus according to the first embodiment of the present invention;

FIG. 3 is a block diagram illustrating a configuration of a reception apparatus according to the first embodiment of the present invention;

FIG. 4 is a block diagram illustrating a configuration of an OFDM demodulation unit of the reception apparatus according to the first embodiment of the present invention;

FIG. 5 is a diagram illustrating first pilot signal patterns in connection with a code-inverted null pilot scheme according to the present invention;

FIG. 6 is a diagram illustrating second pilot signal patterns in connection with a code-inverted null pilot scheme according to the present invention;

FIG. 7 is a diagram illustrating third pilot signal patterns in connection with a code-inverted null pilot scheme according to the present invention;

FIG. 8 is a diagram illustrating fourth pilot signal patterns in connection with a code-inverted null pilot scheme according to the present invention;

FIG. 9 is a diagram illustrating fifth pilot signal patterns in connection with a code-inverted null pilot scheme according to the present invention;

FIG. 10 is a diagram illustrating sixth pilot signal patterns in connection with a code-inverted null pilot scheme according to the present invention;

FIGS. 11A to 11C are diagrams illustrating arrangements of pilot signals of the code-inverted null pilot scheme according to the present invention;

FIG. 12 is a diagram illustrating an arrangement of a pilot signal in connection with terrestrial digital broadcasting;

FIG. 13 is a diagram illustrating examples of application of the pilot signal patterns illustrated in FIG. 9 to the pilot signal arrangements illustrated in FIGS. 11A to 11C;

FIG. 14 is a block diagram illustrating a configuration of a transmission apparatus according to a second embodiment of the present invention;

FIG. 15 is a block diagram illustrating a configuration of a reception apparatus according to the second embodiment of the present invention;

FIG. 16 is a block diagram illustrating a configuration of an OFDM demodulation unit of the reception apparatus according to the second embodiment of the present invention;

FIG. 17 is a block diagram illustrating a configuration of a reception apparatus according to a third embodiment of the present invention;

FIG. 18 is a diagram illustrating pilot signal patterns when a null pilot scheme is applied to a system configured to transmit two OFDM signals in the same frequency band;

FIG. 19 is a diagram illustrating positions of transmission path responses obtained from the pilot signals of FIG. 15;

FIG. 20 is a diagram illustrating pilot signal patterns when a code-inverted pilot scheme is applied to a system configured to transmit two OFDM signals in the same frequency band;

FIG. 21 is a diagram illustrating positions of transmission path responses obtained from the pilot signals of FIG. 17;

FIGS. 22A to 22C are diagrams illustrating pilot signal patterns when the null pilot scheme is applied to a system configured to transmit four OFDM signals in the same frequency band; and

FIGS. 23A to 23D are diagrams illustrating pilot signal patterns when the inverted pilot scheme is applied to a system configured to transmit four OFDM signals in the same frequency band.

### DETAILED DESCRIPTION OF THE PREFERRED EMBODIMENTS

Hereinafter, embodiments of the present invention will be described in detail with reference to the drawings.

### First Embodiment

In the first embodiment, a system configured to perform 4×4 MIMO transmission will be described. The present system includes a transmission apparatus configured to transmit OFDM signals at one transmission station and perform MIMO transmission by means of SDM from four transmission antennas at the transmission station. The present system includes a reception apparatus configured to perform MIMO reception of SDM using four reception antennas.

### OFDM Signal Transmission Apparatus According to First Embodiment

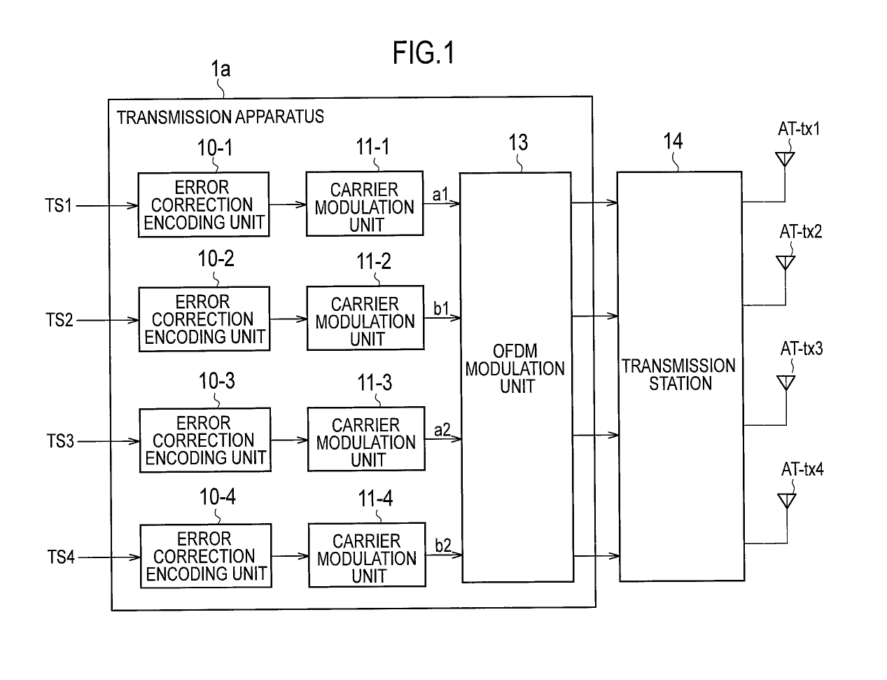

An OFDM signal transmission apparatus according to the first embodiment will be described. FIG. 1 is a block diagram illustrating a configuration of an OFDM signal transmission apparatus according to the first embodiment. As illustrated in FIG. 1, the transmission apparatus 1a includes error correction encoding units 10 (10-1 to 10-4), carrier modulation units 11 (11-1 to 11-4), and an OFDM modulation unit 13. Input signals to the transmission apparatus 1a are Transport Stream (TS) signals TS1 to TS4 of four lines. It is also possible to arrange a TS division apparatus, for example, at a pre-input stage of the transmission apparatus 1a so that a TS of one line is divided into four lines, and the resulting TS signals are input to the transmission apparatus 1a. The transmission apparatus 1a outputs four OFDM signals of four lines, and the four OFDM signals are sent to one transmission station 14.

The transmission station 14 is configured to perform MIMO transmission by means of SDM, from antennas AT-tx1 to AT-tx4.

The error correction encoding units 10 are configured to perform error correction encoding of TS signals and output the TS signals to the carrier modulation units 11. The error correction employs, for example, BCH codes as external codes and employs Low Density Parity Check (LDPC) codes as internal codes.

The carrier modulation units 11 are configured to perform mapping onto an IQ plane according to a predetermined modulation scheme for each sub-carrier and output the mapping to the OFDM modulation unit 13.

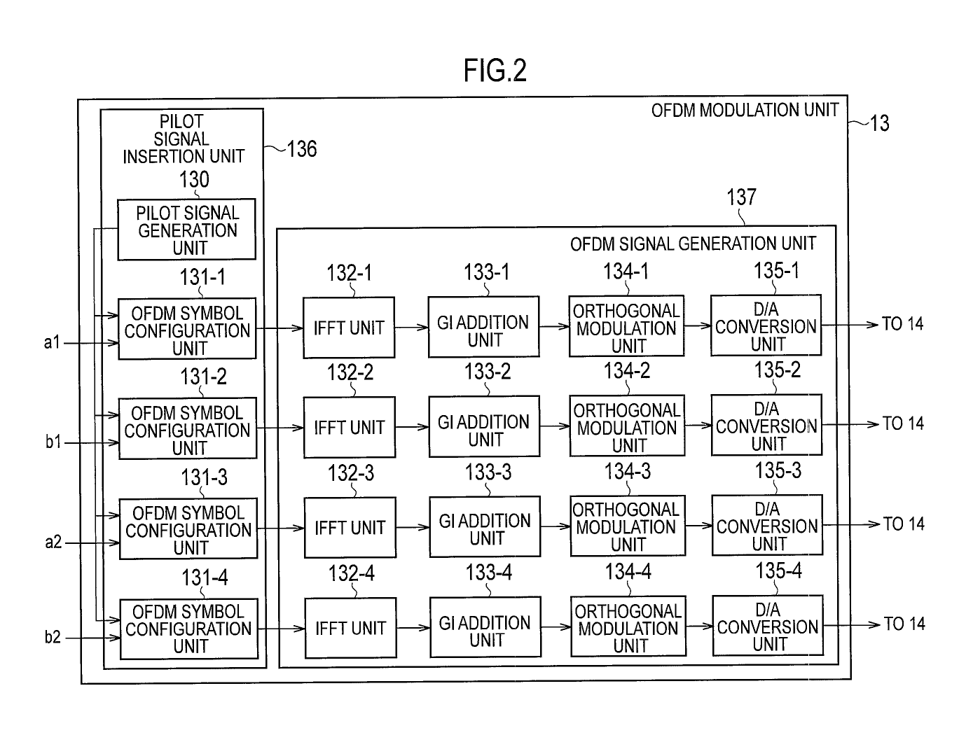

The OFDM modulation unit 13 is configured to generate four OFDM signals of four lines from four types of transmission signals a1, a2, b1, and b2 input from the carrier modulation units 11 and transmit the generated OFDM signals to the transmission station 14. FIG. 2 is a block diagram illustrating a configuration of the OFDM modulation unit 13. As illustrated in FIG. 2, the OFDM modulation unit 13 includes a pilot signal insertion unit 136 and an OFDM signal generation unit 137.

The pilot signal insertion unit 136 is configured to generate four types of OFDM symbols by respectively inserting pilot signals of different patterns into the four types of transmission signals a1, b1, a2, and b2 input from the carrier modulation units 11. The pilot signal insertion unit 136 includes a pilot signal generation unit 130 and OFDM symbol configuration units 131 (131-1 to 131-4).

The pilot signal generation unit 130 is configured to generate pilot signals and output the pilot signals to the OFDM symbol configuration units 131, in order to insert pilot signals, which have predetermined amplitudes and phases, in predetermined positions.

The OFDM symbol configuration units 131 are configured to generate OFDM symbols by inserting and arranging the pilot signals, which are input from the pilot signal generation unit 130, with respect to the four types of transmission signals a1, b1, a2, and b2 input from the carrier modulation units 11, and output the generated OFDM symbols to IFFT units 132.

[Patterns and Arrangements of Pilot Signals]

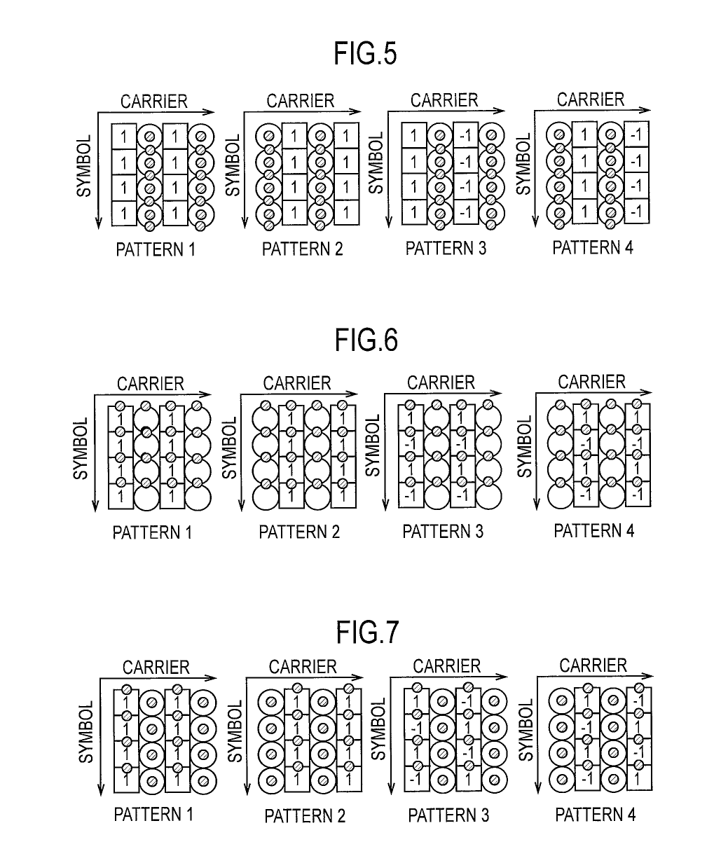

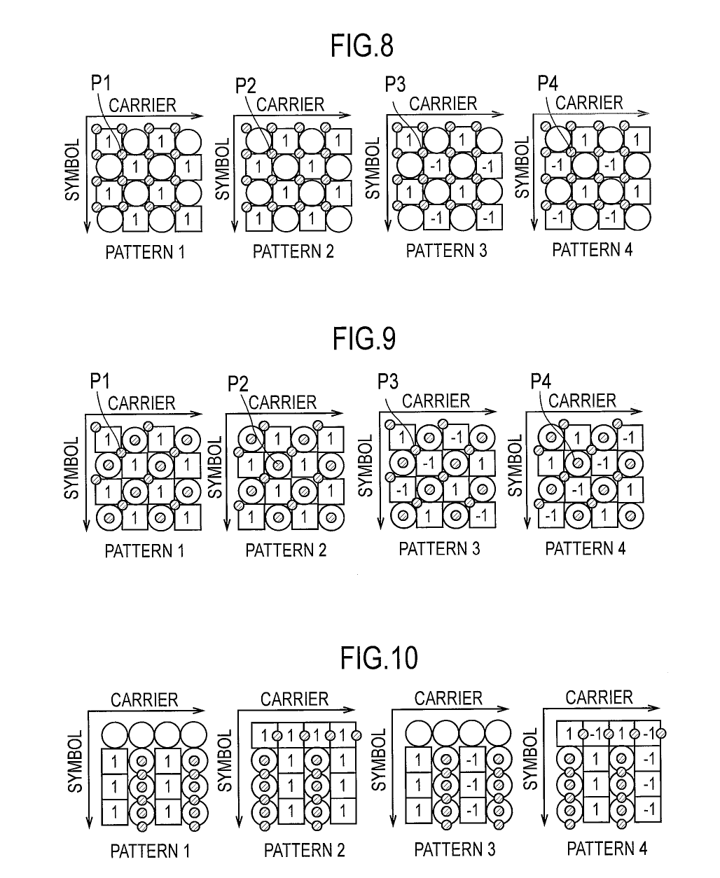

Patterns and arrangements of pilot signals inserted by the pilot signal insertion unit 136 will now be described. In this specification, the pilot signal transmission scheme according to the present invention will be referred to as a code-inverted null pilot scheme. FIGS. 5 to 10 are diagrams illustrating examples of pilot signal patterns in connection with the code-inverted null pilot scheme according to the present invention. In FIGS. 5 to 10, non-pilot signals, such as data signals, are omitted, the smallest unit of repetition of pilot signals is solely illustrated, and positions of transmission path responses directly obtained from pilot signals are indicated by circles marked with oblique lines. In addition, patterns 1 to 4 illustrate arrangements of pilot signals of OFDM signals transmitted from different transmission antennas among the transmission antennas AT-t1 to AT-t4. In the drawings, pilot signals indicated by squires represent signals having a meaningful value, and pilot signals indicated by circles represent null signals. Furthermore, pilot signals labeled “1” and pilot signals labeled “−1” indicate that the signals have inverted codes. In addition, in connection with OFDM symbols in the drawings, the rightward direction corresponds to the carrier (frequency) direction, and the downward direction corresponds to the symbol (time) direction. FIGS. 5 to 7 illustrate examples of arranging pilot signals of null signals in the symbol direction, and FIGS. 8 and 9 illustrate examples of arranging pilot signals of null signals obliquely. FIG. 10 illustrates an example of changing the pattern of pilot signals of first symbols with respect to the pilot signal pattern of FIG. 5, and patterns 2 and 4 can estimate denser transmission path responses in the carrier direction than patterns 1 and 3.

Although not illustrated, the pilot signal generation unit 130 can also arrange pilot signals of null signals in the carrier direction. In this case, the pilot signal patterns become, with respect to the patterns illustrated in FIGS. 5 to 7, patterns having inverted symbol and carrier directions, respectively.

As such, the pilot signal insertion unit 136 inserts, with respect to a first transmission signal and a second transmission signal, pilot signals having a meaningful value and pilot signals of null signals, and inserts, with respect to a third transmission signal and a fourth transmission signal, pilot signals having a meaningful value, pilot signals obtained by inverting codes of the pilot signals having a meaningful value, and pilot signals of null signals. In addition, the pilot signal insertion unit 136 inserts, with respect to the first transmission signal and the third transmission signal, pilot signals of null signals in the same positions and inserts, with respect to the second transmission signal and the fourth transmission signal, pilot signals of null signals in positions different from positions in which pilot signals of null signals have been inserted into the first transmission signal and the third transmission signal.

The first to fourth transmission signals are any of the four types of transmission signals a1, b1, a2, and b2 input from the carrier modulation units 11. In FIGS. 5 to 10, a pilot signal insertion pattern regarding the first transmission signal is illustrated as pattern 1; a pilot signal insertion pattern regarding the second transmission signal is illustrated as pattern 2; a pilot signal insertion pattern regarding the third transmission signal is illustrated as pattern 3; and a pilot signal insertion pattern regarding the fourth transmission signal is illustrated as pattern 4.

The pilot signal insertion unit 136, as illustrated in FIGS. 5 to 9, can also set, with respect to the four types of transmission signals, half of the inserted pilot signals with pilot signals of null signals and insert pilot signals, with respect to the third transmission signal and the fourth transmission signal, so that the number of pilot signals having a meaningful value is equal to the number of pilot signals obtained by inverting codes of the pilot signals having a meaningful value, thereby preferably obtaining uniform positions in which transmission path responses are directly obtained.

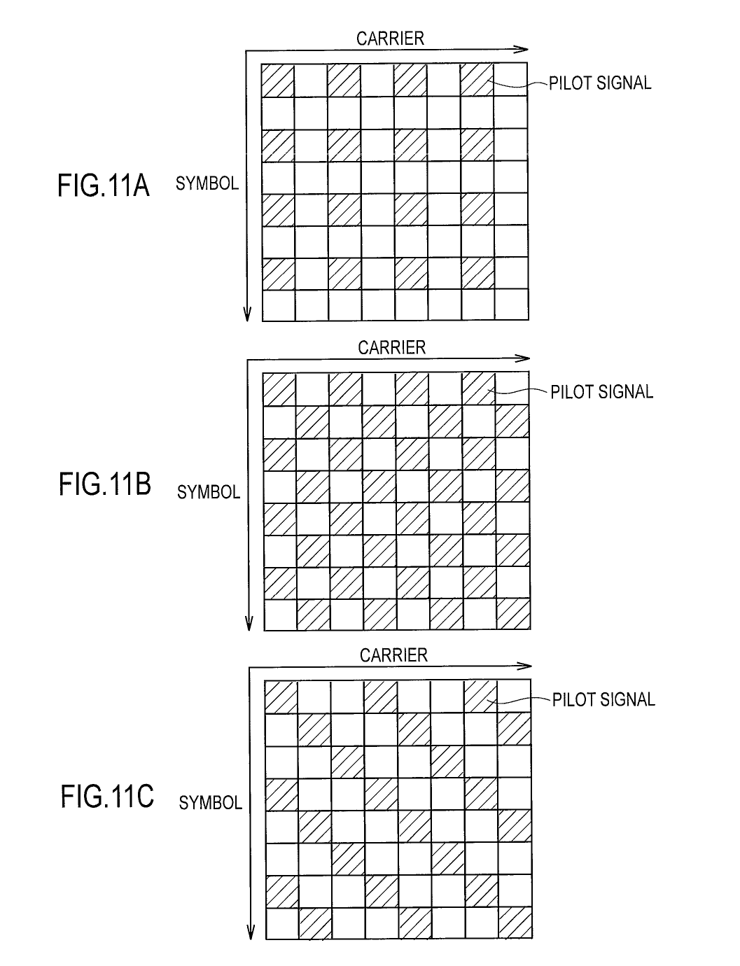

FIG. 11A to FIG. 11C are diagrams illustrating arrangements of pilot signals of the code-inverted null pilot scheme. In the drawings, parts marked with oblique lines indicate arrangement positions of pilot signals, and white parts indicate arrangement positions of non-pilot signals. The non-pilot signals can solely refer to data signals, or the non-pilot signals can include, besides data signals, TMCC signals indicating control information or AC signals indicating additional information. Pilot signals are preferably arranged in a lattice shape as illustrated in FIG. 11A, arranged in a zigzag shape as illustrated in FIG. 11B, or arranged obliquely as illustrated in FIG. 11C. FIGS. 11A to 11C illustrate cases where the arrangement interval of pilot signals in the symbol direction/carrier direction is narrow. As the arrangement interval of pilot signals in the symbol direction/carrier direction is wider, the ratio of pilot signals with respect to the entire signals can be made lower (data signal transmission efficiency increases), but positions of transmission path responses directly obtained may decrease. On the other hand, as the arrangement interval of pilot signals in the symbol direction/carrier direction is lower, the ratio of pilot signals with respect to the entire signals can be made higher (data signal transmission efficiency decreases), but positions of transmission path responses directly obtained may increase.

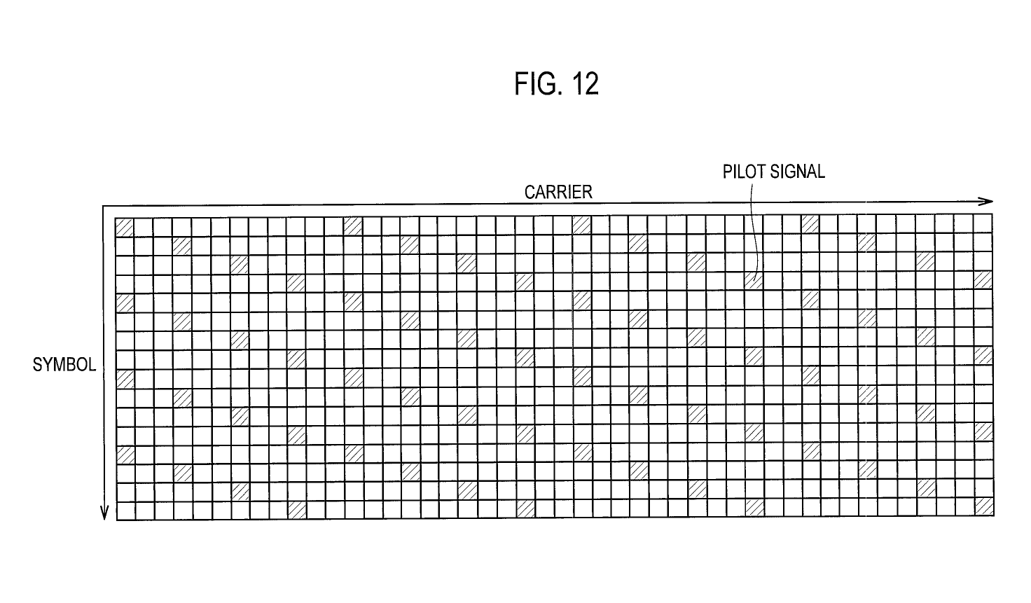

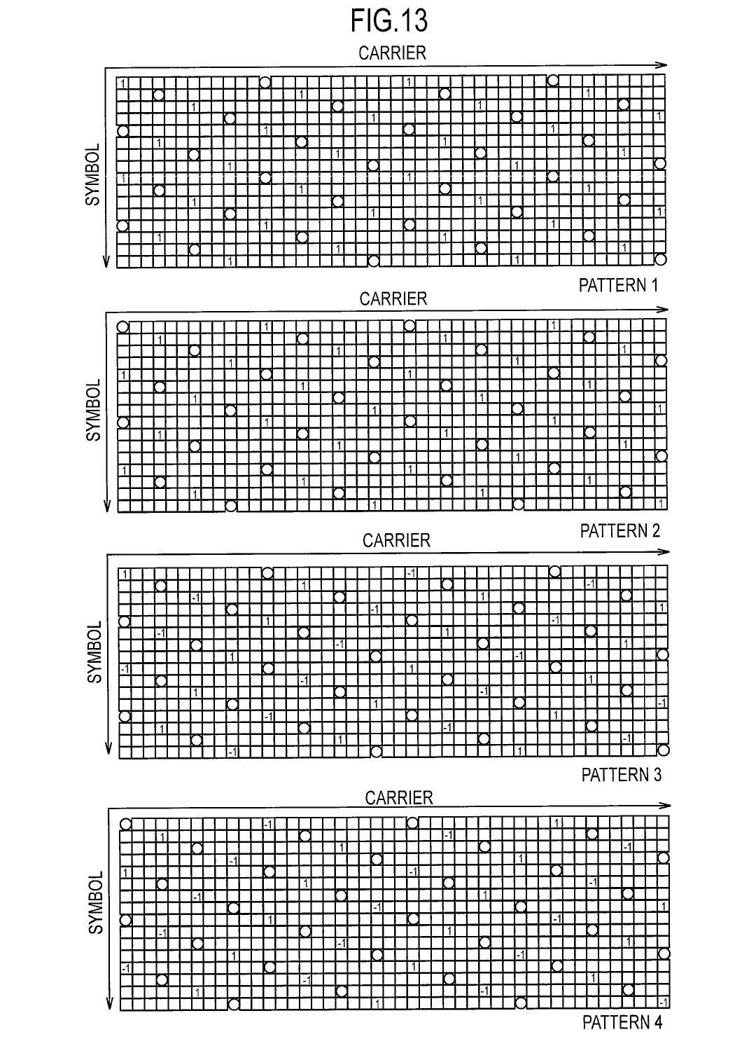

Terrestrial digital broadcasting employs SP (Scattered Pilot) signals as pilot signals. FIG. 12 is a diagram illustrating an arrangement of SP signals in connection with terrestrial digital broadcasting. FIG. 12 illustrates an exemplary mode of arranging the pilot signals, which are illustrated in FIG. 11C, obliquely, and the pilot signals are inserted at a rate of once per twelve carriers and once per four symbols. FIG. 13 is a diagram illustrating an example of applying the pilot signal patterns, which are illustrated in FIG. 9, to the pilot signal arrangement illustrated in FIG. 12.

The OFDM signal generation unit 137 is configured to generate four OFDM signals by modulating respective carriers of OFDM symbols input by the pilot signal insertion unit 136 and output the generated OFDM signals to the four transmission antennas AT-Tx1 to AT-Tx4 via the transmission station 14. The OFDM signal generation unit 137 includes IFFT units 132 (132-1 to 132-4), GI addition units 133 (133-1 to 133-4), orthogonal modulation units 134 (134-1 to 134-4), and D/A conversion units 135 (135-1 to 135-4). The OFDM signal generation unit 137 also supplies each block with a clock of the same frequency, in order to obtain synchronization of the four OFDM signals.

The IFFT units 132 are configured to generate valid symbol signals in the time domain by performing Inverse Fast Fourier Transform (IFFT) processing with respect to OFDM symbols input from the OFDM symbol configuration units 131 and output the generated valid symbol signals to the GI addition units 133.

The GI addition units 133 are configured to insert guard intervals, which are obtained by copying rear-half portions of valid symbol signals input from the IFFT units 132, at the heads of the valid symbol signals and output the resulting signals to the orthogonal modulation units 134. The guard intervals are inserted to reduce interference between symbols when receiving OFDM signals, and are set so that the delay time of multipath delay waves does not exceed the guard interval length.

The orthogonal modulation units 134 are configured to generate OFDM signals by performing orthogonal modulation processing with respect to baseband signals input from the GI addition units 133 and output the generated OFDM signals to the D/A conversion units 135.

The D/A conversion units 135 are configured to convert the OFDM signals, which are input from the orthogonal modulation units 134, into analog signals.

As such, the transmission apparatus 1a according to the first embodiment, by means of the pilot signal insertion unit 136, as illustrated in FIGS. 5 to 10, inserts, with respect to first and second transmission signals, pilot signals having a meaningful value and pilot signals of null signals; inserts, with respect to third and fourth transmission signals, pilot signals having a meaningful value, pilot signals obtained by inverting codes of the pilot signals having a meaningful value, and pilot signals of null signals; inserts, with respect to the first and third transmission signals, pilot signals of null signals in the same predetermined positions; and inserts, with respect to the second and fourth transmission signals, pilot signals of null signals in positions different from the same predetermined positions. As a result, in the range of four symbols×four carriers, transmission path responses are obtained at a high frequency, and power consumption for transmitting pilot signals can be reduced. For example, when the transmission apparatus 1a sets, with respect to the four types of transmission signals, half of the inserted pilot signals with pilot signals of null signals and inserts pilot signals, with respect to the third and fourth transmission signals, so that the number of pilot signals having a meaningful value is equal to the number of pilot signals obtained by inverting codes of the pilot signals having a meaningful value, sixteen points of transmission path responses can be obtained directly (without using interpolation), and power consumption for transmitting pilot signals can be reduced by half.

### OFDM Signal Reception Apparatus According to the First Embodiment

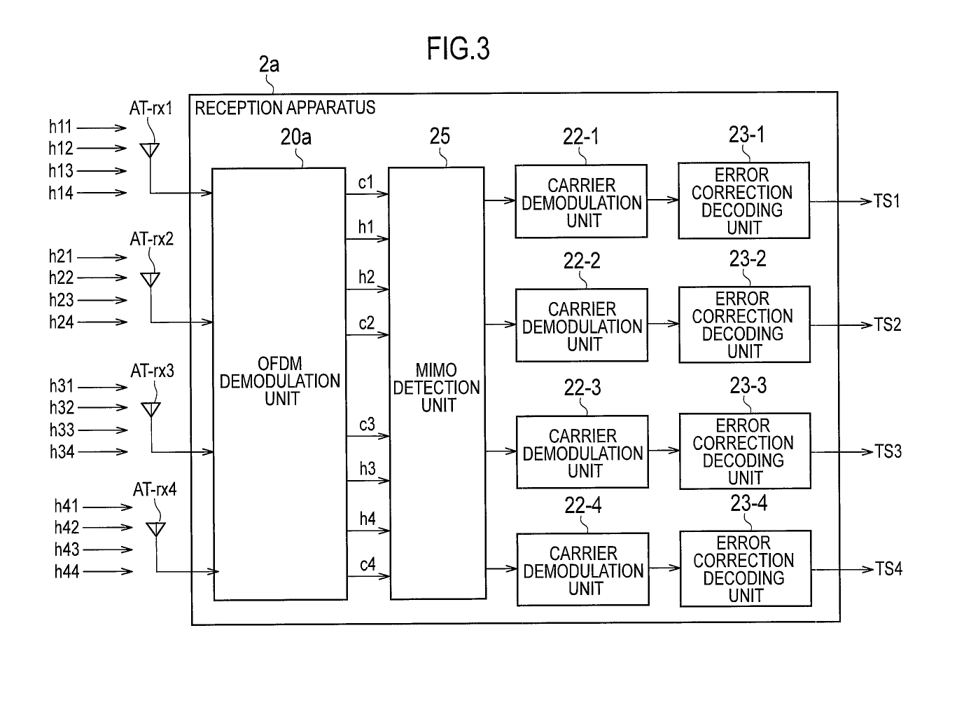

Next, an OFDM signal reception apparatus according to the first embodiment will be described. FIG. 3 is a block diagram illustrating a configuration of an OFDM signal reception apparatus according to the first embodiment. As illustrated in FIG. 3, the OFDM signal reception apparatus 2a includes an OFDM demodulation unit 20a, a MIMO detection unit 25, carrier demodulation units 22 (22-1 to 22-4), and error correction decoding units 23 (23-1 to 23-4). The reception apparatus 2a is configured to receive four OFDM signals of four lines, which are transmitted from the transmission apparatus 1a, using four reception antennas AT-rx1 to AT-rx4.

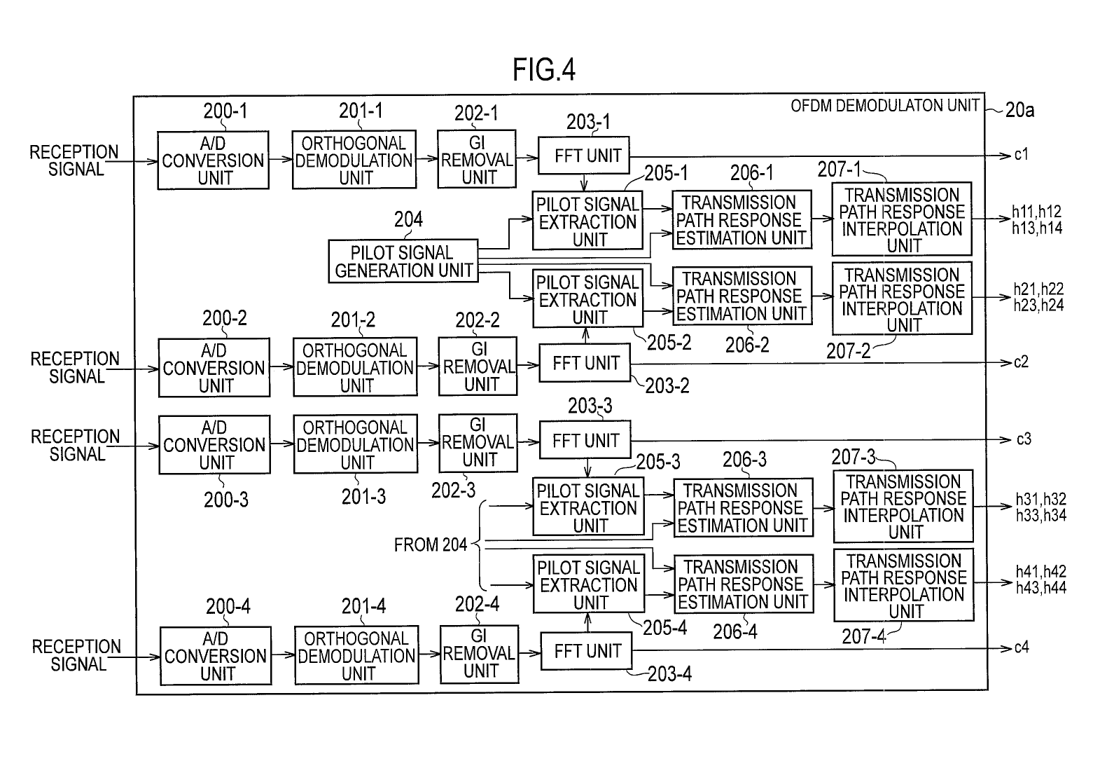

The OFDM demodulation unit 20a is configured to generate four types of baseband signals c1, c2, c3, and c4 by demodulating the received four OFDM signals and estimate four types of transmission path responses h1, h2, h3, and h4 using pilot signals. FIG. 4 is a block diagram illustrating a configuration of the OFDM demodulation unit 20a. As illustrated in FIG. 4, the OFDM demodulation unit 20a includes A/D conversion units 200 (200-1 to 200-4), orthogonal demodulation units 201 (201-1 to 201-4), GI removal units 202 (202-1 to 202-4), FFT units 203 (203-1 to 203-4), a pilot signal generation unit 204, pilot signal extraction units 205 (205-1 to 205-4), transmission path response estimation units 206 (206-1 to 206-4), and transmission path response interpolation units 207 (207-1 to 207-4).

The A/D conversion units 200 are configured to convert analog reception signals, which are input from the antennas AT-rx, into digital signals and output the digital signals to the orthogonal demodulation units 201.

The orthogonal demodulation units 201 are configured to generate baseband signals with respect to the signals input from the A/D conversion units 200 and output the generated baseband signals to the GI removal units 202.

The GI removal units 202 are configured to extract valid symbol signals by removing guard intervals with respect to the signals input from the orthogonal demodulation units 201 and output the extracted valid symbol signals to the FFT units 203.

The FFT units 203 are configured to generate complex baseband signals c1 and c2 by performing Fast Fourier Transform (FFT) processing with respect to the valid symbol signals input from the GI removal units 202 and output the generated complex baseband signals c1 and c2 to the pilot signal extraction units 205.

The pilot signal generation unit 204 is configured to generate pilot signals having the same amplitude and phase as those of pilot signals inserted by the transmission apparatus 1a, output position information regarding the pilot signals inserted by the transmission apparatus 1a to the pilot signal extraction units 205, and output the amplitude and phase values of the pilot signals to the transmission path response estimation units 206.

The pilot signal extraction units 205 are configured to extract pilot signals from the complex baseband signals c1 and c2 input from the FFT units 203, based on the position information input from the pilot signal generation unit 204, and output the extracted pilot signals to the transmission path response estimation units 206.

The transmission path response estimation units 206 are configured to calculate transmission path responses using the pilot signals extracted by the pilot signal extraction units 205. For example, transmission path responses of positions of points P1 to P4 of FIG. 8 are obtained, assuming that the amplitude value of pilot signals is one, from the following equations:

P1: h1=(Rx(1, 1)+Rx(2, 2))/2

P2: h2=(Rx(1, 2)+Rx(2, 1))/2

P3: h3=(Rx(1, 1)−Rx(2, 2))/2

P4: h4=(Rx(1, 2)−Rx(2, 1))/2

In addition, transmission path responses of positions of points P1 to P4 of FIG. 9 are obtained, assuming that the amplitude value of pilot signals is one, from the following equations:

P1: h1=(Rx(1, 1)+Rx(2, 2))/2

P2: h2=(Rx(1, 2)+Rx(2, 1))/2

P3: h3=(Rx(1, 1)−Rx(2, 2))/2

P4: h4=(Rx(2, 1)−Rx(2, 3))/2

The transmission path response interpolation units 207 are configured to calculate transmission path responses with respect to the entire sub-carriers by performing interpolation processing of transmission path responses, based on a part or all of the transmission path responses calculated by the transmission path response estimation units 206.

The MIMO detection unit 25 is configured to detect MIMO signals using baseband signals c and transmission path responses h, which are input from the OFDM demodulation unit 20a. Detection of MIMO can be performed by applying various known methods, such as Zero Forcing (ZF), Minimum Mean Squared Error (MMSE), Bell Laboratories Layered Space-Time (BLAST), and Maximum Likelihood Detection (MLD).

The carrier demodulation units 22 are configured to perform demodulation for each sub-carrier, with respect to signals input from the OFDM demodulation unit 20a, and output the demodulated signals to the error correction decoding units 23.

The error correction decoding units 23 are configured to decode signals transmitted from the transmission apparatus 1a by performing error correction with respect to signals input from the carrier demodulation units 22.

As such, the reception apparatus 2a according to the first embodiment makes it possible to receive OFDM signals, which are transmitted from the transmission apparatus 1a, using four reception antennas and decode the received OFDM signals.

### Second Embodiment

In connection with current terrestrial digital television broadcasting, construction of Single Frequency Network (SFN) is in progress in terms of efficient use of frequencies, but transmission characteristics deteriorate in a SFN interference area where the D/U (Desired to Undesired signal ratio) of SFN desired waves and SFN interference waves approaches 0 dB. In the case of an OFDM signal transmission system employing Space-Time Coding (STC), transmission characteristics are improved in the SFN interference area, where the D/U is near 0 dB, enabling efficient use of frequencies. In the second embodiment, apparatuses for transmitting and receiving OFDM signals using STC will be described. In the second embodiment, furthermore, a system configured to perform 4×2 MIMO transmission will be described. The transmission apparatus of the present system is configured to transmit OFDM signals at two transmission stations and perform MIMO transmission by means of SDM from two transmission antennas at one transmission station. The reception apparatus of the present system is configured to perform MIMO reception of SDM using two reception antennas.

### OFDM signal Transmission Apparatus According to Second Embodiment

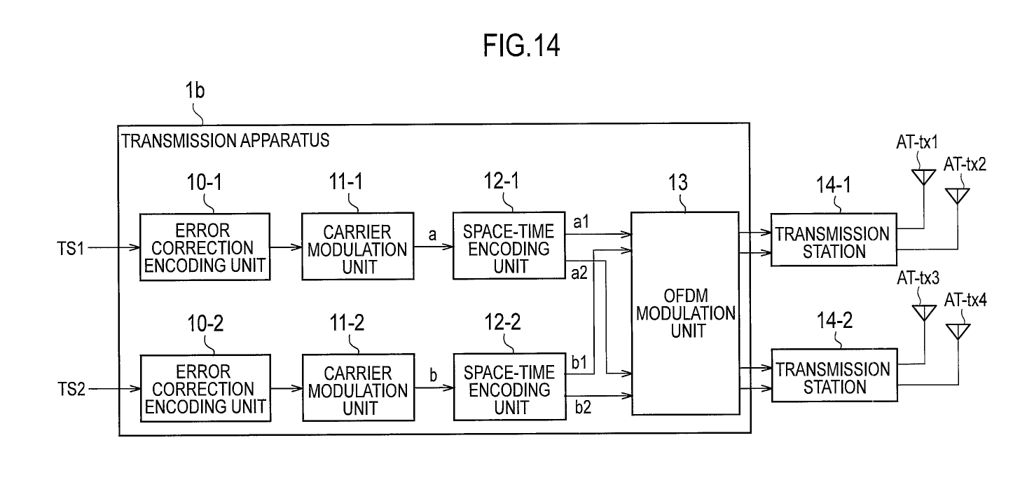

The OFDM signal transmission apparatus according to the second embodiment will be described. FIG. 14 is a block diagram illustrating a configuration of the OFDM signal transmission apparatus according to the second embodiment. The same components as those of the transmission apparatus 1a according to the first embodiment will be given the same reference numerals, and repeated descriptions thereof will be omitted herein. As illustrated in FIG. 14, the transmission apparatus 1b includes error correction encoding units 10 (10-1 and 10-2), carrier modulation units 11 (11-1 and 11-2), STC units 12 (12-1 and 12-2), and an OFDM modulation unit 13. Input signals to the transmission apparatus 1b are TS signals TS1 and TS2 of two lines. It is also possible to arrange a TS division apparatus, for example, at a pre-input stage of the transmission apparatus 1b so that a TS of one line is divided into two lines, and the resulting TS signals are input to the transmission apparatus lb. The transmission apparatus 1b outputs four OFDM signals of two lines, and two OFDM signals are sent to the transmission station 14-1, while remaining two OFDM signals are sent to the transmission station 14-2.

The transmission station 14-1 is configured to perform MIMO transmission by means of SDM from antennas AT-tx1 and AT-tx2. The transmission station 14-2 is configured to perform MIMO transmission by means of SDM from antennas AT-tx3 and AT-tx4.

As in the case of the transmission apparatus 1a according to the first embodiment, the error correction encoding units 10 are configured to perform error correction encoding of TS signals, and the carrier modulation units 11 are configured to perform mapping, with respect to each sub-carrier, onto an IQ plane according to a predetermined modulation scheme.

The STC units 12 are configured to generate four types of STC signals a1, a2, b1, and b2 by performing STC with respect to respective signals a and b of two lines, which are input from the carrier modulation units 11, and output the generated STC signals to the OFDM modulation unit 13. When Space-Time Block Coding (STBC) of Alamouti is applied as the STC, the STC unit 12-1 perform STC (STBC encoding) of a complex baseband signal a, which is to be transmitted, and outputs the resulting signals a1 and a2, and the STC unit 12-2 performs STC (STBC encoding) of a complex baseband signal b, which is to be transmitted, and outputs the resulting signals b1 and b2. Assuming that the value of a complex baseband signal to be transmitted is x1, x2, x3, and x4 (wherein, x₁=a(m), x₂=a(m+1), x₃=b(m), and x₄=b(m+1)), STBC encoding gives a1, a2, b1, and b2 the following values:

a₁(m)=x₁

a₁(m+1)=−x*₂

a₂(m)=x₂

a₂(m+1)=x*₁

b₁(m)=x₃

b₁(m+1)=−x*₄

b₂(m)=x₄

b₂(m+1)=x*₃

wherein, m refers to a discrete time, and * refers to complex conjugates.

The OFDM modulation unit 13 is configured to generate four OFDM signals of two lines from four types of STC signals a1, a2, b1, and b2, which are input from the STC units 12, and transmit the generated OFDM signals to the transmission stations 14-1 and 14-2. The transmission stations 14-1 and 14-2 are configured to transmit MIMO-OFDM signals by means of SDM in the same frequency band. The OFDM modulation unit 13 has the same configuration as illustrated in FIG. 2, and a description thereof will not be repeated herein.

As such, the transmission apparatus 1b according to the second embodiment further includes STC units 12 configured to perform STC with respect to each of signals of two lines and generate four types of STC signals. This can improve transmission characteristics in a SFN interference area where D/U is near 0 dB.

### OFDM Signal Reception Apparatus According to Second Embodiment

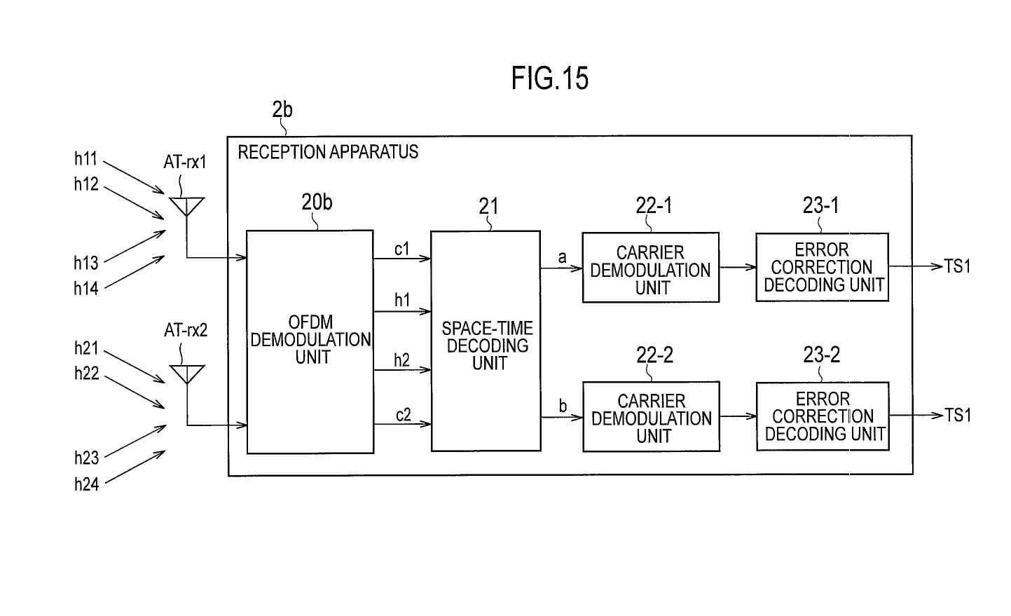

Next, the OFDM signal reception apparatus according to the second embodiment will be described. FIG. 15 is a block diagram illustrating a configuration of the OFDM signal reception apparatus according to the second embodiment. The same components as those of the reception apparatus 2a according to the first embodiment are given the same reference numerals, and repeated descriptions thereof will be omitted herein. As illustrated in FIG. 15, the OFDM signal reception apparatus 2b includes an OFDM demodulation unit 20b, a space-time decoding unit 21, carrier demodulation units 22 (22-1 and 22-2), and error correction decoding units 23 (23-1 and 23-2). The reception apparatus 2b is configured to receive four OFDM signals of two lines, which are transmitted from the transmission apparatus 1b, using two reception antennas AT-rx1 and AT-rx2.

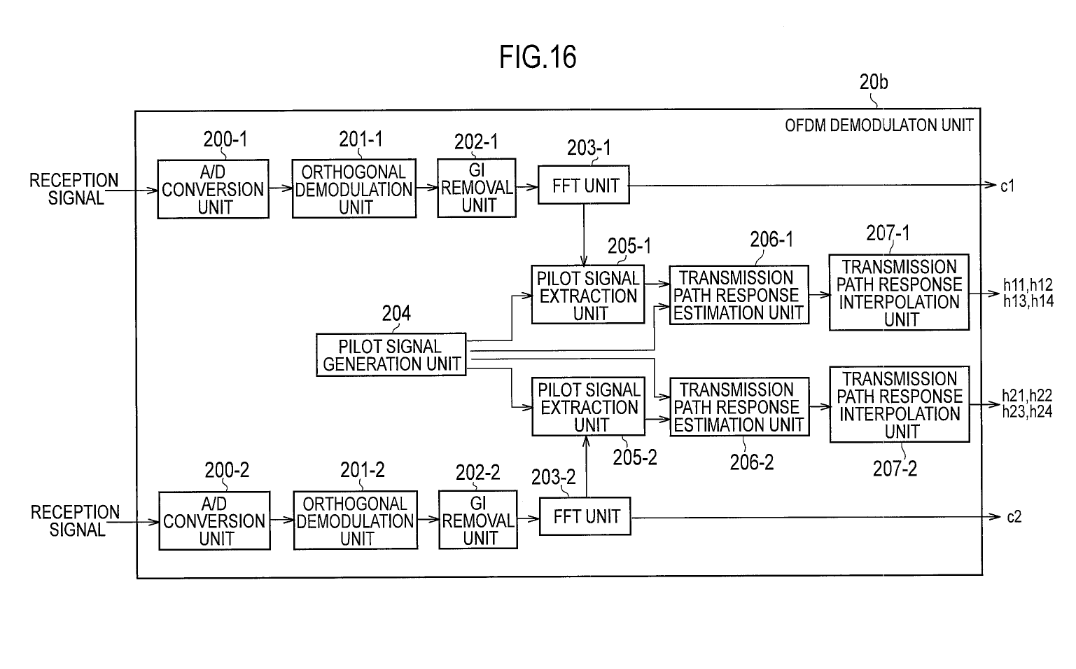

The OFDM demodulation unit 20b is configured to generate two types of baseband signals c1 and c2 by demodulating the received four OFDM signals of two lines and estimate two types of transmission path responses h1 and h2 using pilot signals. FIG. 16 is a block diagram illustrating a configuration of the OFDM demodulation unit 20b. As illustrated in FIG. 16, the OFDM demodulation unit 20b includes A/D conversion units 200 (200-1 and 200-2), orthogonal demodulation units 201 (201-1 and 201-2), GI removal units 202 (202-1 and 202-2), FFT units 203 (203-1 and 203-2), a pilot signal generation unit 204, pilot signal extraction units 205 (205-1 and 205-2), transmission path response estimation units 206 (206-1 and 206-2), and transmission path response interpolation units 207 (207-1 and 207-2). The OFDM demodulation unit 20a according to the first embodiment performs demodulation processing of four OFDM signals, but the OFDM demodulation unit 20b according to the second embodiment performs demodulation processing of two OFDM signals. Particulars of processing by respective processing blocks are the same as in the case of the OFDM demodulation unit 20a according to the first embodiment, and repeated descriptions thereof will be omitted herein.

The space-time decoding unit 21 is configured to generate space-time decoding signals by performing space-time decoding using complex baseband signals c1 and c2, transmission path responses h11, h12, h13, and h14 (referred to as h1 in FIG. 15), and transmission path responses h21, h22, h23, and h24 (referred to as h2 in FIG. 15), which are input from the OFDM demodulation unit 20b. Hereinafter, a method of calculating space-time decoding signals will be described.

The complex baseband signals c1 and c2, which become inputs to the space-time decoding unit 21, are regarded as signals obtained when complex baseband signals a1, a2, b1, and b2, which have been transmitted from the transmission apparatus 1b, pass through a transmission path having a transmission path response of

$$[ \begin{matrix}{h}_{11} & {h}_{12} & {h}_{13} & {h}_{14} \\ {h}_{21} & {h}_{22} & {h}_{23} & {h}_{24}\end{matrix} ]$$

and have noise z1 and z2 added thereto. Therefore, the complex baseband signals c1 and c2 are defined by in following equation (1):

$$\begin{matrix}[ Mathematical Formula 1 ] & \\ \begin{matrix}[ \begin{matrix}{c}_{1} ( m ) \\ {c}_{2} ( m )\end{matrix} ] = [ \begin{matrix}{h}_{11} & {h}_{12} & {h}_{13} & {h}_{14} \\ {h}_{21} & {h}_{22} & {h}_{23} & {h}_{24}\end{matrix} ] [ \begin{matrix}{a}_{1} ( m ) \\ {b}_{1} ( m ) \\ {a}_{2} ( m ) \\ {b}_{2} ( m )\end{matrix} ] + [ \begin{matrix}{z}_{1} ( m ) \\ {z}_{2} ( m )\end{matrix} ] \\ = [ \begin{matrix}{h}_{11} & {h}_{12} & {h}_{13} & {h}_{14} \\ {h}_{21} & {h}_{22} & {h}_{23} & {h}_{24}\end{matrix} ] [ \begin{matrix}{x}_{1} \\ {x}_{3} \\ {x}_{2} \\ {x}_{4}\end{matrix} ] + [ \begin{matrix}{z}_{1} ( m ) \\ {z}_{2} ( m )\end{matrix} ]\end{matrix} & ( 1 )\end{matrix}$$

Assuming that the transmission path response does not change at time m+1, inputs c1 and c2 at time m+1 are defined by in following equation (2), and taking complex conjugates of both sides of equation (2) leads to following equation (3):

$$\begin{matrix} [ Mathematical Formula 2 ] & \\ [ \begin{matrix}{c}_{1} ( m + 1 ) \\ {c}_{2} ( m + 1 )\end{matrix} ] = [ \begin{matrix}{h}_{11} & {h}_{12} & {h}_{13} & {h}_{14} \\ {h}_{21} & {h}_{22} & {h}_{23} & {h}_{24}\end{matrix} ] [ \begin{matrix}{a}_{1} ( m + 1 ) \\ {b}_{1} ( m + 1 ) \\ {a}_{2} ( m + 1 ) \\ {b}_{2} ( m + 1 )\end{matrix} ] + [ \begin{matrix}{z}_{1} ( m + 1 ) \\ {z}_{2} ( m + 1 )\end{matrix} ] & ( 2 ) \\ \begin{matrix}[ \begin{matrix}{c}_{1}^{*} ( m + 1 ) \\ {c}_{2}^{*} ( m + 1 )\end{matrix} ] = [ \begin{matrix}{h}_{11}^{*} & {h}_{12}^{*} & {h}_{13}^{*} & {h}_{14}^{*} \\ {h}_{21}^{*} & {h}_{22}^{*} & {h}_{23}^{*} & {h}_{24}^{*}\end{matrix} ] [ \begin{matrix}{a}_{1}^{*} ( m + 1 ) \\ {b}_{1}^{*} ( m + 1 ) \\ {a}_{2}^{*} ( m + 1 ) \\ {b}_{2}^{*} ( m + 1 )\end{matrix} ] + [ \begin{matrix}{z}_{1}^{*} ( m + 1 ) \\ {z}_{2}^{*} ( m + 1 )\end{matrix} ] \\ = [ \begin{matrix}{h}_{13}^{*} & {h}_{14}^{*} & - {h}_{11}^{*} & - {h}_{12}^{*} \\ {h}_{23}^{*} & {h}_{24}^{*} & - {h}_{21}^{*} & - {h}_{22}^{*}\end{matrix} ] [ \begin{matrix}{x}_{1} \\ {x}_{3} \\ {x}_{2} \\ {x}_{4}\end{matrix} ] + [ \begin{matrix}{z}_{1}^{*} ( m + 1 ) \\ {z}_{2}^{*} ( m + 1 )\end{matrix} ]\end{matrix} & ( 3 )\end{matrix}$$

By mean of equations (1) and (3), decoding of STBC corresponds to solving following equation (4) and obtaining x1, x2, x3, and x4:

$$\begin{matrix}[ Mathematical Formula 3 ] & \\ [ \begin{matrix}{c}_{1} ( m ) \\ {c}_{1}^{*} ( m + 1 ) \\ {c}_{2} ( m ) \\ {c}_{2}^{*} ( m + 1 )\end{matrix} ] = [ \begin{matrix}{h}_{11} & {h}_{12} & {h}_{13} & {h}_{14} \\ {h}_{13}^{*} & {h}_{14}^{*} & - {h}_{11}^{*} & - {h}_{12}^{*} \\ {h}_{21} & {h}_{22} & {h}_{23} & {h}_{24} \\ {h}_{23}^{*} & {h}_{24}^{*} & - {h}_{21}^{*} & - {h}_{22}^{*}\end{matrix} ] + [ \begin{matrix}{z}_{1} ( m ) \\ {z}_{1}^{*} ( m + 1 ) \\ {z}_{2} ( m ) \\ {z}_{2}^{*} ( m + 1 )\end{matrix} ] & ( 4 )\end{matrix}$$

In solving equation (4), ZF (Zero Forcing), MMSE (Minimum Mean Squared Error), MLD (Maximum Likelihood Detection), and the like can be applied. When the ZF is applied to separate four streams, the procedure is as follows. In connection with equation (4), a weight matrix W is defined by following equation (5):

$$\begin{matrix}[ Mathematical Formula 4 ] & \\ W = {( {H}^{H} H )}^{- 1} {H}^{H} \\ where , \\ H = [ \begin{matrix}{h}_{11} & {h}_{12} & {h}_{13} & {h}_{14} \\ {h}_{13}^{*} & {h}_{14}^{*} & - {h}_{11}^{*} & - {h}_{12}^{*} \\ {h}_{21} & {h}_{22} & {h}_{23} & {h}_{24} \\ {h}_{23}^{*} & {h}_{24}^{*} & - {h}_{21}^{*} & - {h}_{22}^{*}\end{matrix} ] & ( 5 )\end{matrix}$$

Multiplying weight matrixes W from the left on both sides of equation (5) leads to following equation (6):

$$\begin{matrix}[ Mathematical Formula 5 ] & \\ \begin{matrix}W [ \begin{matrix}{c}_{1} ( m ) \\ {c}_{1}^{*} ( m + 1 ) \\ {c}_{2} ( m ) \\ {c}_{2}^{*} ( m + 1 )\end{matrix} ] = WH [ \begin{matrix}{x}_{1} \\ {x}_{2} \\ {x}_{3} \\ {x}_{4}\end{matrix} ] + W [ \begin{matrix}{z}_{1} ( m ) \\ {z}_{1}^{*} ( m + 1 ) \\ {z}_{2} ( m ) \\ {z}_{2}^{*} ( m + 1 )\end{matrix} ] \\ = {( {H}^{H} H )}^{- 1} {H}^{H} H [ \begin{matrix}{x}_{1} \\ {x}_{2} \\ {x}_{3} \\ {x}_{4}\end{matrix} ] + W [ \begin{matrix}{z}_{1} ( m ) \\ {z}_{1}^{*} ( m + 1 ) \\ {z}_{2} ( m ) \\ {z}_{2}^{*} ( m + 1 )\end{matrix} ] \\ = [ \begin{matrix}{x}_{1} \\ {x}_{2} \\ {x}_{3} \\ {x}_{4}\end{matrix} ] + W [ \begin{matrix}{z}_{1} ( m ) \\ {z}_{1}^{*} ( m + 1 ) \\ {z}_{2} ( m ) \\ {z}_{2}^{*} ( m + 1 )\end{matrix} ]\end{matrix} & ( 6 )\end{matrix}$$

Ignoring noise components of equation (6), x1, x2, x3, and x4 are obtained by following equation (7):

$$\begin{matrix}[ Mathematical Formula 6 ] & \\ [ \begin{matrix}{x}_{1} \\ {x}_{2} \\ {x}_{3} \\ {x}_{4}\end{matrix} ] ≅ W [ \begin{matrix}{c}_{1} ( m ) \\ {c}_{1}^{*} ( m + 1 ) \\ {c}_{2} ( m ) \\ {c}_{2}^{*} ( m + 1 )\end{matrix} ] & ( 7 )\end{matrix}$$

As such, the space-time decoding unit 21 calculates space-time decoding signals x₁, x₂, x₃, and x₄ (that is, a(m), a(m+1), b(m), and b(m+1)), based on equation (7), using complex baseband signals c1 and c2, transmission path responses h11, h12, h13, and h14, and transmission path responses h21, h22, h23, and h24, which are input from the OFDM demodulation unit 20b.

Furthermore, even when SFBC (Space-Frequency Block Coding) is applied as the SPC, encoding and decoding are possible according to the same procedure as in the case of STBC. It has been assumed in the above description of STBC that m refers to a discrete time, but SFBC can be applied in the same manner based on a different assumption that m refers to a sub-carrier number.

The carrier demodulation units 22 are configured to perform demodulation for each sub-carrier with respect to signals input from the space-time decoding unit 21 and output the demodulated signals to the error correction decoding units 23.

The error correction decoding units 23 are configured to perform error correction with respect to signals input from the carrier demodulation units 22 and decode signals, which are transmitted from the transmission apparatus 1b.

As such, by means of the reception apparatus 2b, it is possible to receive OFDM signals, which are transmitted from the transmission apparatus 1b, by the two reception antennas, to demodulate the received OFDM signals by the OFDM demodulation unit 20b, and to perform space-time decoding by the space-time decoding unit 21.

### Third Embodiment

Next, as a third embodiment, apparatuses for transmitting and receiving OFDM signals, which constitute a 4×4 MIMO transmission system, will be described. In the third embodiment, the transmission apparatus is the same as in the second embodiment, and there are two transmission stations, at one of which MIMO transmission is performed by means of SDM from two transmission antennas. The reception apparatus is configured to perform MIMO reception of SDM using four reception antennas.

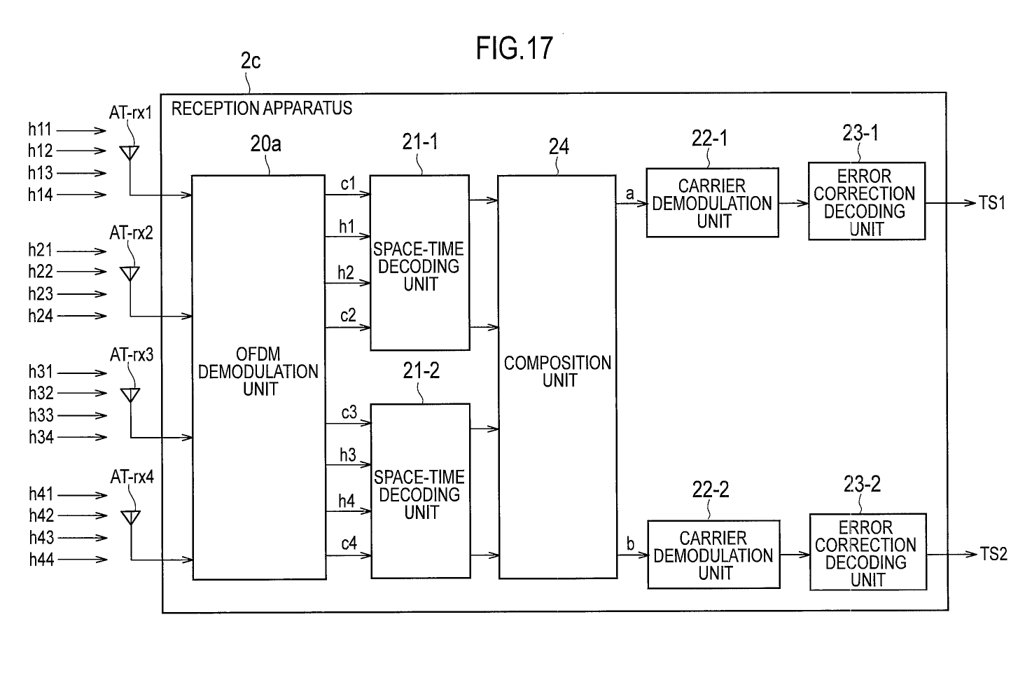

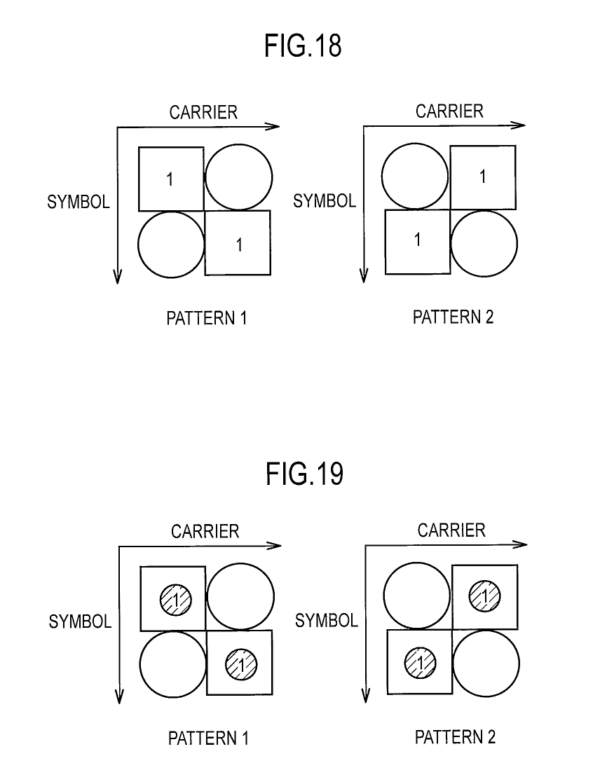

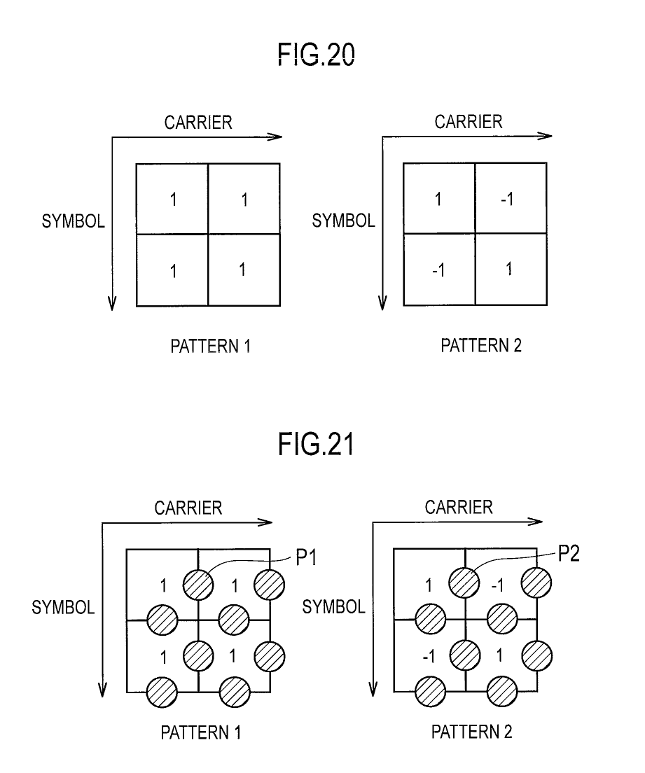

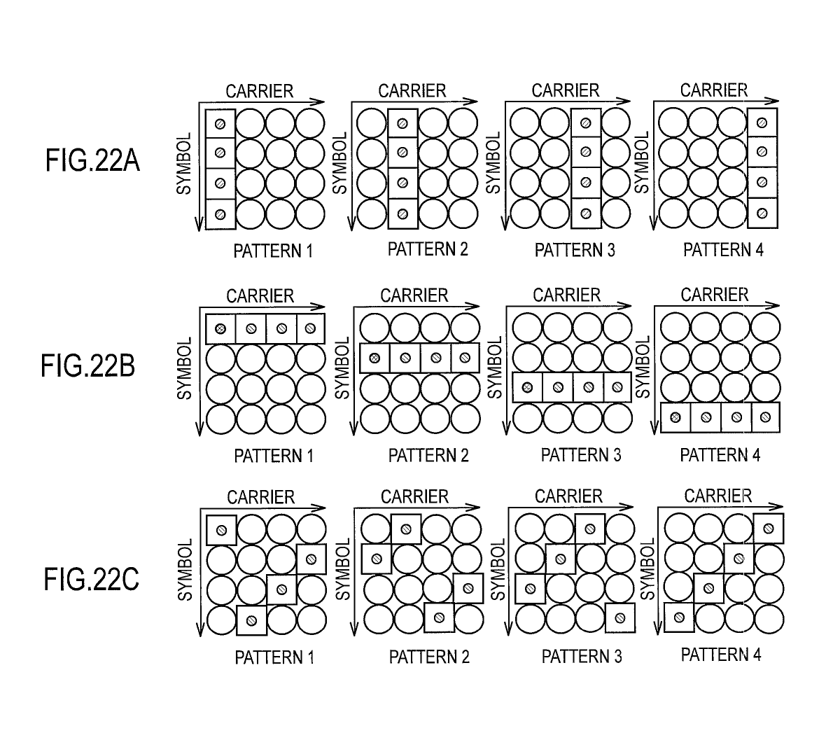

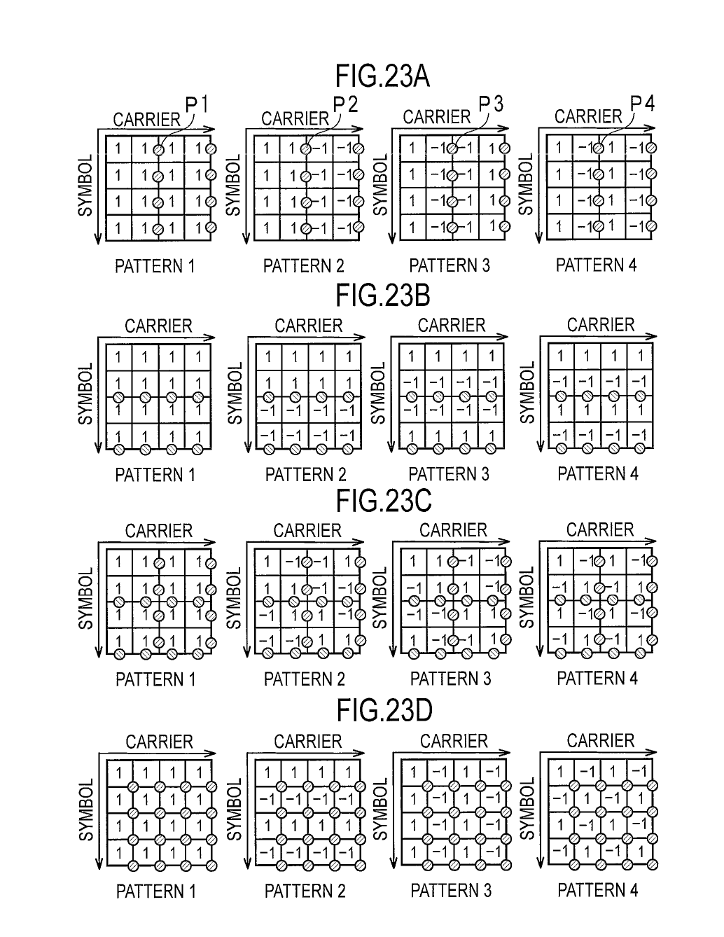

The transmission apparatus according to the third embodiment is the same as the transmission apparatus 1b illustrated in FIG. 14 of the second embodiment, which performs 4×2 MIMO transmission, and a description thereof will not be repeated herein. FIG. 17 is a block diagram illustrating a configuration of the reception apparatus 2c according to the third embodiment. The same components as those of the reception apparatus 2b according to the second embodiment are given the same reference numerals, and repeated descriptions thereof will be omitted herein. The reception apparatus 2c according to the third embodiment includes an OFDM demodulation unit 20a, space-time decoding units 21, carrier demodulation units 22, error correction decoding units 23, and a composition unit 24. The reception apparatus 2c is configured to receive four OFDM signals, which are transmitted from the transmission apparatus 1b, using four reception antennas AT-rx1 to AT-rx4. The reception apparatus 2c according to the third embodiment is different from the reception apparatus 2b according to the second embodiment in that the OFDM demodulation unit 20a estimates four types of transmission path responses, which correspond to four reception antennas, and that the OFDM demodulation unit 20a includes a composition unit 24.

The OFDM demodulation unit 20a is the same as described with reference to FIG. 4 in the first embodiment, and a description thereof will not be repeated herein.

The space-time decoding unit 21-1 is configured to generate space-time decoding signals x1, x2, x3, and x4 by performing space-time decoding, based on equation (7), using complex baseband signals c1 and c2, transmission path responses h11, h12, h13, and h14 (referred to as h1 in FIG. 17), and transmission path responses h21, h22, h23, and h24 (referred to as h2 in FIG. 17), which are input from the OFDM demodulation unit 20a. Similarly, the space-time decoding unit 21-2 is configured to generate space-time decoding signals x1, x2, x3, and x4 by performing space-time decoding using complex baseband signals c3 and c4, transmission path responses h31, h32, h33, and h34 (referred to as h3 in FIG. 17), and transmission path responses h41, h42, h43, and h44 (referred to as h4 in FIG. 17), which are input from the OFDM demodulation unit 20a.

The composition unit 24, considering that decoding results are respectively obtained from the space-time decoding units 21-1 and 21-2, performs diversity composition by applying a selective composition method, an in-phase composition method, a maximum ratio composition, and the like, which are known in the art, with respect to two sets of obtained space-time decoding signals x1, x2, x3, and x4, finally obtaining one set of x1, x2, x3, and x4.

In addition, even when SFBC has been applied as the STC, encoding and decoding are possible in the same procedure as in the case of STBC. It has been assumed in the above description of STBC according to the first embodiment that m refers to a discrete time, but it is possible to apply SFBC, based on a different assumption that m refers to a sub-carrier number, and to obtain x1, x2, x3, and x4 from reception signals c1 and c2. Furthermore, x1, x2, x3, and x4 are also obtained from reception signals c3 and c4 similarly. By performing diversity composition with respect to two sets of obtained x1, x2, x3, and x4 and estimating final x1, x2, x3, and x4, diversity gain is obtained with respect to 4×2 MIMO.

As such, the reception apparatus 2c according to the third embodiment receives OFDM signals, which are transmitted from the transmission apparatus 1b, by four reception antennas, demodulates the received OFDM signals by the OFDM demodulation unit 20a, performs space-time decoding by the space-time decoding units 21, and then performs diversity composition of the space-time decoding signals by the composition unit 24. This makes it possible to obtain diversity gain with respect to 4×2 MIMO of the second embodiment. It is also possible to improve the diversity gain by additionally increasing the number of reception antennas.

Although the above embodiments have been described respectively as representative examples, it is obvious to those skilled in the art that a number of modifications and substitutions are possible without departing from the idea and scope of the present invention. Therefore, the present invention is not to be interpreted as being limited by the above-described embodiments, but various changes or modifications are possible without departing from the accompanying claims.

### INDUSTRIAL APPLICABILITY

According to the present invention, in connection with a transmission system using a plurality of OFDM signals of the same frequency band, transmission path responses can be obtained at a high frequency, and power consumption for transmitting pilot signals can be reduced.

1. A transmission apparatus for transmitting four OFDM signals from four transmission antennas, the transmission apparatus comprising:
a pilot signal insertion unit configured to generate four types of OFDM symbols by inserting pilot signals of different patterns into four types of transmission signals; and
an OFDM signal generation unit configured to generate four OFDM signals by modulating respective carriers of the four types of OFDM symbols,
wherein the pilot signal insertion unit is configured to:
insert, with respect to first and second transmission signals, pilot signals having a meaningful value and pilot signals of null signals; insert, with respect to third and fourth transmission signals, pilot signals having a meaningful value, pilot signals obtained by inverting codes of the pilot signals having a meaningful value, and pilot signals of null signals;
insert, with respect to the first and third transmission signals, the pilot signals of null signals in identical predetermined positions; and
insert, with respect to the second and fourth transmission signals, the pilot signals of null signals in positions different from the identical predetermined positions.

2. The transmission apparatus according to claim 1, further comprising a space-time encoding unit configured to generate four types of space-time encoding signals by performing space-time encoding with respect to signals of two lines, respectively,
wherein the four types of transmission signals are the four types of space-time encoding signals generated by the space-time encoding unit.

3. The transmission apparatus according to claim 1, wherein the pilot signal insertion unit is configured to:
set, with respect to the four types of transmission signals, half the number of inserted pilot signals with pilot signals of null signals; and
insert, with respect to the third and fourth transmission signals, pilot signals so that the number of the pilot signals having a meaningful value is equal to the number of pilot signals obtained by inverting codes of the pilot signals having a meaningful value.

4. A reception apparatus for receiving four OFDM signals transmitted from the transmission apparatus according to claim 1, using four reception antennas, the reception apparatus comprising:
an OFDM demodulation unit configured to demodulate the received four OFDM signals and estimate baseband signals corresponding to respective reception antennas and transmission path responses.

5. A reception apparatus for receiving four OFDM signals transmitted from the transmission apparatus according to claim 2, using two reception antennas, the reception apparatus comprising:
an OFDM demodulation unit configured to demodulate the received four OFDM signals and estimate baseband signals corresponding to respective reception antennas and transmission path responses; and
a space-time decoding unit configured to generate space-time decoding signals by performing space-time decoding using the baseband signals and the transmission path responses.

6. A reception apparatus for receiving four OFDM signals transmitted from the transmission apparatus according to claim 2, using at least four reception antennas, the reception apparatus comprising:
an OFDM demodulation unit configured to demodulate the received four OFDM signals and estimate baseband signals corresponding to respective reception antennas and transmission path responses;
a space-time decoding unit configured to generate space-time decoding signals by performing space-time decoding using the baseband signals and the transmission path responses; and
a composition unit configured to perform diversity composition of the space-time decoding signals.
